(19) United States
(12) Patent Application Publication
(10) Pub. No.: US 2010/0017201 A1
(43) Pub. Date: Jan. 21, 2010

(54) Data embedding apparatus, data extraction apparatus, and voice communication system

(75) Inventors: Masakiyo Tanaka, Kawasaki (JP); Yasuji Ota, Kawasaki (JP); Masanao Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,153

(22) Filed: Sep. 4, 2009

Related U.S. Application Data
(63) Continuation of application No. PCT/JP2007/055722, filed on Mar. 20, 2007.

(51) Int. Cl. G10L 19/00; G10L 11/04

(52) U.S. Cl. 704/207; 704/500; 704/E19.009; 700/94

(57) ABSTRACT

A voice communication system having, on a transmission side, a data embedding apparatus provided with an embedding allowability judgment unit (41) calculating an analysis parameter with respect to an input audio signal and judging based on the analysis parameter whether there is a part of the input audio signal allowing embedding of data and an embedding unit (42) outputting an audio signal having the data embedded in the allowable part when the result of judgment of the embedding allowability judgment unit is data can be embedded and outputting the audio signal as is when the result of judgment of the embedding allowability judgment unit is data cannot be embedded and having, on the receiving side, a data extraction apparatus provided with a data extraction apparatus extracting data by a reverse operation is provided, whereby data can be embedded in voice signals without causing an unallowable change in audio quality and a drop in amount of embedded data due to embedding data in parts unsuitable for embedding data.

### CROSS-REFERENCE TO RELATED APPLICATIONS

This application is a continuation application based on International Patent Application PCT/JP2007/55722, filed on Mar. 20, 2007, the entire contents of which are incorporated herein by reference.

### FIELD

The present invention relates to digital audio signal processing technology, more particularly relates to a data embedding apparatus replacing a portion of a digital data series of an audio signal with any kind of different information to thereby embed any kind of digital data in an audio signal, a data extraction apparatus extracting data embedded this way, and a voice communication system including a data embedding apparatus and a data extraction apparatus.

### BACKGROUND

In recent years, “data embedding technology” for embedding any kind of data into multimedia content and other digital series has been drawing attention. This is technology utilizing the features of human senses to embed any kind of different information in the multimedia content itself without affecting quality.

Data embedding technology is often applied for movies or images, however several technologies for embedding such any kind of information in audio signals as well for transmission or storage have been proposed.

FIG. 1 is a schematic view explaining the embedding of data in an audio signal and the extraction of the embedded data.

FIG. 1(A) illustrates the processing at the data embedding side, and FIG. 1(B) illustrates the processing at the data extracting side. First, at the embedding side, as illustrated in FIG. 1(A), the embedding unit 11 replaces a portion of an audio signal with embedding data to thereby embed data. On the other hand, at the data extracting side, as illustrated in FIG. 1(B), the extraction unit 12 extracts, from the audio signal in which the input data is embedded, the part replaced with the different data and restores the embedded data. Therefore, it is possible to insert any kind of different data without increasing the amount of information within the audio signal. That is, using data embedding technology has the merit of not increasing the required data storage capacity and not putting additional strain on the transmission band (more than in normal communication) during voice communication. Further, third parties, who are unaware of data being embedded, perceive it only to be normal audio data/voice communication, so this is an effective means when storing and transmitting/receiving ID information, PIN numbers, and other highly confidential information.

In such data embedding technology, it is important to not lower the quality of the multimedia content in which the data is embedded. Therefore, when embedding data in an audio signal, it is necessary to embed the data in a way that does not affect the audio quality. As basic technology for embedding data realizing this, there are the following (1) to (3).

(1) Embedding in Lower Order Bits

Generally, digital audio signals are recorded by the system called PCM (pulse code modulation). This system expresses an amplitude of a signal sampled by AD conversion by a predetermined number of bits. In particular, the system expressing one sample by 16 bits is being used widely in music CDs etc. Conventional embedding technology utilizes the fact that even if modifying (inverting) lower order bits of 16 bit PCM, there is little effect on the audio quality and replaces the one lowest order bit, for example, to any value so as to embed data.

(2) Embedding in a Frequency Domain

The audio signal is converted by time-frequency conversion to a signal of the frequency domain and data is embedded in a value of the frequency band with little effect on the audio quality. For example, there is a method of embedding data in a frequency band with a low amplitude and a method for embedding data in a phase component utilizing the fact that changes in phase have little effect on acoustic perception.

(3) Embedding in Encoded Data

In mobile phones, the recently rapidly increasingly used music download services, etc., audio signals are transmitted by encoded data compressed in order to make effective use of the transmission band. The encoded data consists of a plurality of parameters expressing the properties of voice. In technology embedding data into encoded data, data is embedded in codes having little effect on audio quality in these parameters.

In the basic technologies set forth in the above (1) to (3), parts having little effect on audio quality are selected for embedding data, however, there is the problem that whether the part at which the data is to be embedded is a part suitable for embedding is not taken into account. That is, with the basic technologies, there is the problem that it is not judged whether the part at which the data is to be embedded is a part allowing data to be embedded in the input audio signal. Accordingly, with the basic technologies, embedding data may cause the audio quality to deteriorate. As methods for solving this problem, there are the prior art mentioned below.

Prior Art 1 (Patent Document 1)

FIG. 2 is a view illustrating an image of embedding data according to a Prior Art 1. The Prior Art 1 utilizes the fact that even if embedding data into the signal changes the amplitude value of a signal, the effect which that change in the amplitude value of the signal has on the audio quality of the signal is small at a part “a” where the fluctuation in the amplitude of the signal is large and embeds data targeting as the lower order bits of the signal at a part where the fluctuation in amplitude is large to thereby embed data without causing a deterioration in audio quality. That is, as illustrated in FIG. 2(B), the amplitude value of the signal prior to embedding data at the time t was a1, while the amplitude value of the signal after embedding data became a2, however, the difference between a1 and a2 is one of an extent which listeners are unable to discern at a part where the fluctuation in the amplitude value of the signal is large.

Prior Art 2 (Patent Document 2)

FIG. 3 is a view illustrating an image of embedding data according to a Prior Art 2. According to the Prior Art 2, by inserting into a signal (silent) interval having a very small amplitude difficult for humans to perceive as illustrated in FIG. 3(A) a similar signal of a very small amplitude difficult for humans to perceive as illustrated in FIG. 3(B) as an embedded signal, embedding of data is realized without changing the audio quality. For example, the amplitude of a 16 bit PCM voice signal is a value of 32767 to 32768, while the amplitude of the signal illustrated in FIG. 3(B) is 1 or extremely small compared with the maximum amplitude. Even if embedding this kind of very small amplitude signal in a silent interval or very small signal interval as illustrated in FIG. 3(A), there is no large effect on the quality of the signal.

### [Patent Document 1] Japanese Patent No. 3321876

### [Patent Document 2] Japanese Laid-Open Patent Publication No. 2000-68970

### SUMMARY

### Problem to be Solved by the Invention

The object of all of the above prior arts is to select a part appropriate for embedding data and embed data in it, however, with the method of selection according to the prior art, there is the problem that it is not possible to suitably select a part suitable for embedding data, that is, a part allowing embedding of data. Here, first, what kind of part a part suitable for embedding data is will be explained below.

If viewing audio signals from the viewpoint of embedding data, audio signals may be classified into the three following classifications A, B, and C.

A. Part at which a Change in Audio Quality Due to Embedding Data Cannot be Audibly Perceived

The very small signals of the Prior Art 2 and white noise (random signal) intervals etc. correspond to this part. In the former, there is no change in audio quality because the signals cannot be audibly perceived in the first place, while in the latter, the signals were originally random ones, so even if these signals are similarly randomly changed by embedding data, the changes in the audio quality are not felt.

B. Part at which a Change in Audio Quality Due to Embedding Data is Audibly Acceptable

Intervals having noise that is constant such as automobile engine noise and is not important to humans correspond to this part. In this case, the change in the audio quality due to embedding data is perceivable, however, because the noise is not important to humans, the change in audio quality is acceptable.

C. Part at which a Change in Audio Quality Due to Embedding Data is Audibly Unacceptable

Intervals of speech or music or non-constant noise (talking from surrounding people etc. For example, announcements at train stations) correspond to this part. In these intervals, a change in audio quality due to embedding data will cause for example the voice of the other party in a call to be distorted and hard to hear, noise to enter the music being listened to, announcements in train stations heard in the background of a call to be distorted and become jarring noise, and other deterioration in the audio quality, so changes in audio quality cannot be allowed.

Among these, A and B are part suitable for embedding data, while C is a part not suitable for embedding data. If examining the prior art in accordance to these categories, Prior Art 1 embeds data at a part where the fluctuation in amplitude is large, however, at each of the A, B, and C parts, there will be parts with large fluctuations in amplitude. That is, it is possible to embed data at a C part at which a change in audio quality is audibly unacceptable. Further, Prior Art 2 embeds data only at parts of A, that is, very small signal portions, so cannot embed data in constant noise and the like corresponding to the B part. That is, the amount of data which can be embedded is reduced. In particular, if considering application to voice communication, in general, when engaging in voice communication, it is usually performed with some sort of background noise, so Prior Art 2 can no longer embed data.

The present invention was made in consideration of the above problems and has as its object the provision of a data embedding and extracting method capable of embedding data in an audio signal without loss of audio quality by appropriately judging the parts to embed data in and embedding the data in them.

### Means for Solving the Problems

According to a first aspect of the present invention, there is provided a data embedding apparatus provided with an embedding allowability judgment unit calculating an analysis parameter with respect to an input audio signal and judging based on the analysis parameter whether there is a part of the input audio signal allowing embedding of data and an embedding unit outputting the audio signal embedded with data in the allowable part when the result of judgment of the embedding allowability judgment unit is embedding is possible and outputting the audio signal as is when the result of judgment of the embedding allowability judgment unit is that embedding is not possible.

In the above first aspect, the embedding allowability judgment unit is preferably provided with a preprocessing unit setting a target embedding part of the input audio signal as a default value and outputting the same, at least one characteristic quantity calculation unit from among a power calculation unit calculating a characteristic quantity relating to a power of the audio signal having the target embedding part set to the default value by the preprocessing unit, a power dispersion calculation unit calculating a characteristic quantity relating to a dispersion of power using the characteristic quantity relating to the power of the audio signal calculated by the power calculation unit and a characteristic quantity relating to the power of a past audio signal, and a pitch extraction unit calculating a characteristic quantity relating to periodicity using the audio signal having the target embedding part set to the default value, and a judgment unit judging allowability of embedding data using a characteristic quantity calculated by a characteristic quantity calculation unit.

As a further modification of the above first aspect, there is provided a data embedding apparatus wherein the embedding allowability judgment unit is provided with at least one characteristic quantity calculation unit from among a power calculation unit calculating a characteristic quantity relating to a power of the input audio signal, a power dispersion calculation unit calculating a characteristic quantity relating to a dispersion of power using the characteristic quantity relating to the power of the audio signal calculated by the power calculation unit and a characteristic quantity relating to the power of a past audio signal, and a pitch extraction unit calculating a characteristic quantity relating to periodicity using the audio signal, and a judgment unit judging allowability of embedding data using a characteristic quantity calculated by a characteristic quantity calculation unit and wherein the embedding unit embeds data or processes output of the audio signal based on the result of judgment of the judgment unit for one frame before the input audio signal.

As a further modification of the above first aspect, there is provided a data embedding apparatus wherein the embedding allowability judgment unit is provided with a masking threshold calculation unit calculating a masking threshold of the input audio signal, a temporary embedding unit temporarily embedding data in the audio signal, an error calculation unit calculating an error between a temporarily embedded signal in which data is embedded by the temporary embedding unit and the audio signal, and a judgment unit judging allowability of embedding data using the masking threshold and the error.

According to a second aspect of the present invention, there is provided a data extraction apparatus provided with an embedding judgment unit calculating an analysis parameter with respect to the input audio signal and judging, based on the analysis parameter, whether data is embedded in the input audio signal and an extraction unit extracting data embedded in the audio signal when the result of judgment of the embedding judgment unit indicates data is embedded.

There is provided a data extraction apparatus wherein the embedding judgment unit is provided with a preprocessing unit setting a target embedding part of the input audio signal as a default value and outputting the same, at least one characteristic quantity calculation unit from among a power calculation unit calculating a characteristic quantity relating to a power of the audio signal having the target embedding part set to the default value by the preprocessing unit, a power dispersion calculation unit calculating a characteristic quantity relating to dispersion of power using the characteristic quantity relating to the power of the audio signal calculated by the power calculation unit and a characteristic quantity relating to the power of a past audio signal, and a pitch extraction unit calculating a characteristic quantity relating to periodicity using the audio signal having the target embedding part set to the default value, and an embedding identification unit identifying whether data is embedded using a characteristic quantity calculated by a characteristic quantity calculation unit.

As a further modification of the above second aspect, there is provided a data extraction apparatus wherein the embedding judgment unit is provided with at least one characteristic quantity calculation unit from among a power calculation unit calculating a characteristic quantity relating to a power of the input audio signal, a power dispersion calculation unit calculating a characteristic quantity relating to dispersion of power using the characteristic quantity relating to the power of the audio signal calculated by the power calculation unit and a characteristic quantity relating to the power of a past audio signal, and a pitch extraction unit calculating a characteristic quantity relating to periodicity using the audio signal, and an embedding identification unit identifying whether data is embedded using a characteristic quantity calculated by a characteristic quantity calculation unit and wherein the extraction unit extracts data based on the result of judgment of the embedding judgment unit for one frame before the input audio signal.

According to a third aspect of the present invention, there is provided a voice communication system provided with a data embedding apparatus according to the above first aspect and a data extraction apparatus according to the second aspect.

### EFFECTS OF THE INVENTION

By embedding and extracting data according to the present invention, it possible to embed data into a voice signal without causing the problem of the Prior Art 1, that is, an unallowable change in audio quality due to embedding data in a part unsuitable for embedding data, and without causing the problem of the Prior Art 2, that is, a drop in the embedded amount.

The present invention will be more clearly understood with the preferable embodiments as set forth below with reference to the drawings.

### BRIEF DESCRIPTION OF THE DRAWINGS

FIG. 1 is a schematic view explaining the embedding of data in an audio signal and the extracting of the embedded data.

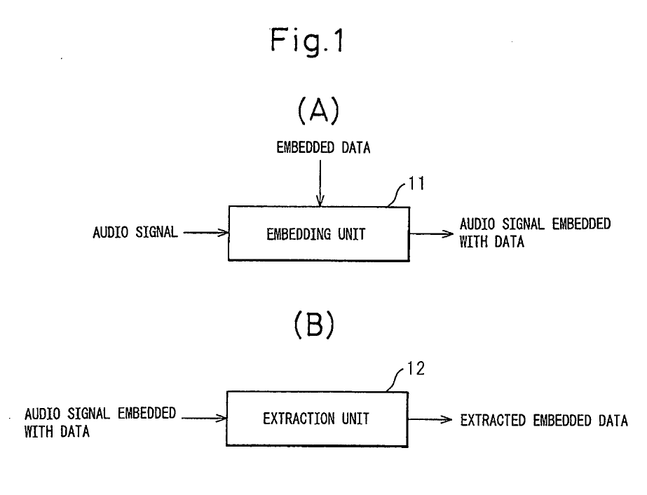

FIG. 2 is a view illustrating an image of embedding data according to a Prior Art 1.

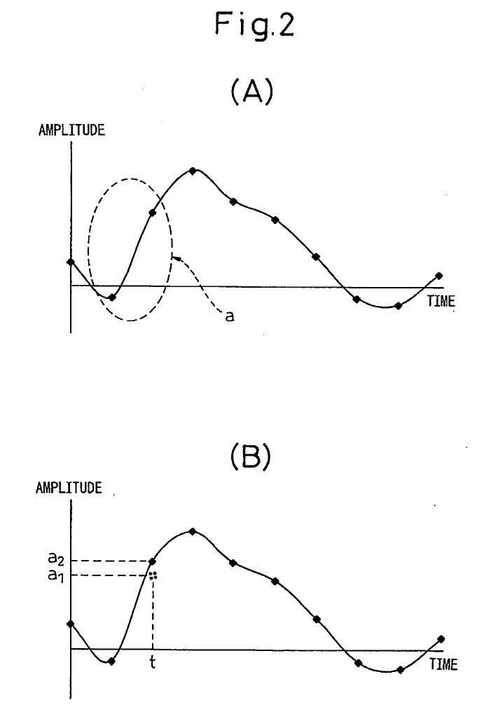

FIG. 3 is a view illustrating an image of embedding data according to a Prior Art 2.

FIG. 4 (A) is a block diagram illustrating an overview of a data embedding apparatus according to an embodiment of the present invention, and (B) is a block diagram illustrating an overview of a data extraction apparatus according to an embodiment of the present invention.

FIG. 5 is a block diagram illustrating a configuration of a data embedding apparatus according to a first embodiment of the present invention.

FIG. 6 is a block diagram illustrating a configuration of a data extraction apparatus according to a first embodiment of the present invention.

FIG. 7 is a flow chart explaining operations of the embedding allowability judgment unit 55.

FIG. 8 is a block diagram illustrating a configuration of a data embedding apparatus according to a second embodiment of the present invention.

FIG. 9 is a block diagram illustrating a configuration of a data extraction apparatus according to a second embodiment of the present invention.

FIG. 10 is a block diagram illustrating a configuration of a data embedding apparatus according to a third embodiment of the present invention.

FIG. 11 is a block diagram illustrating a configuration of a data extraction apparatus according to a third embodiment of the present invention.

### DESCRIPTION OF NOTATIONS

41 embedding allowability judgment unit
42 embedding unit
44 embedding judgment unit
45 extraction unit
51 preprocessing unit
52 power calculation unit
53 power dispersion calculation unit
54 pitch extraction unit
55 embedding allowability judgment unit
56 embedding unit
61 preprocessing unit
62 power calculation unit
63 power dispersion calculation unit
64 pitch extraction unit
65 embedding judgment unit
66 extraction unit
81 delay element
82 power calculation unit
83 power dispersion calculation unit
84 pitch extraction unit
85 embedding allowability judgment unit
86 embedding unit
91 delay element
92 power calculation unit
93 power dispersion calculation unit
94 pitch extraction unit
95 embedding judgment unit
96 extraction unit
101 temporary embedding unit
102 error calculation unit
103 masking threshold calculation unit
104 embedding allowability judgment unit
105 output signal selection unit
111 extraction unit

### DESCRIPTION OF EMBODIMENTS

Below, embodiments of the present invention will be explained with reference to the drawings.

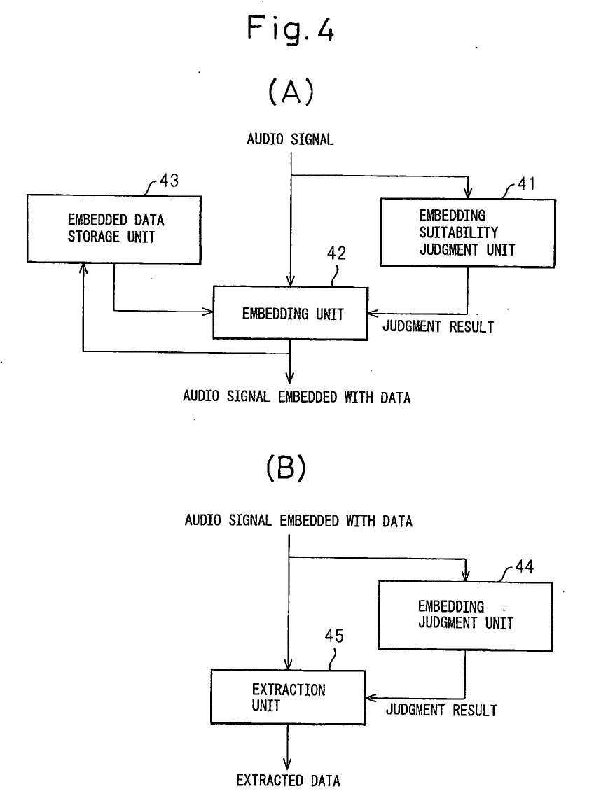

FIG. 4(A) is a block diagram illustrating an overview of a data embedding apparatus according to an embodiment of the present invention. In FIG. 4(A), the data embedding apparatus is provided with an embedding allowability judgment unit 41 calculating an analysis parameter with respect to the input audio signal and judging from the analysis parameter whether there is a part in the input audio signal allowing embedding of data, an embedding unit 42 embedding data in an audio signal according to a predetermined embedding method when the result of judgment of the embedding allowability judgment unit 41 is data can be embedded and outputting the audio signal as is when the result of judgment of the embedding allowability judgment unit 41 is data cannot be embedded, and an embedded data storage unit 43.

Next, the operations of the data embedding apparatus illustrated in FIG. 4(A) will be explained.

First, the audio signal is input into the embedding allowability judgment unit 41. This judges whether data can be embedded in the audio signal (whether it is a part suitable for embedding data or not). Note that, as long as the judgment method is a method judging from a physical parameter and other analysis parameter whether the audio signal is a “part suitable for embedding data where a change in audio quality is not perceived or is acceptable” or a “part unsuitable for embedding data where a change in audio quality is unallowable”, any judgment method may be used. Specific examples of analysis parameters are explained in the embodiments.

If the result of the judgment in the embedding allowability judgment unit 41 is “data can be embedded”, the audio signal and embedding data are input into the embedding unit 42. There, the embedding data stored in the embedded data storage unit 43 is embedded into the audio signal by a predetermined embedding method and output. If “data cannot be embedded”, the audio signal is output as is without embedding the data. Further, for the next audio signal, the result of whether the data is embedded is output to the embedded data storage unit 43. As a result, the embedded data storage unit 43 may judge which data is the next to embed.

FIG. 4(B) is a block diagram illustrating an overview of a data extraction apparatus according to an embodiment of the present invention. In FIG. 4(B), the data extraction apparatus is provided with an embedding judgment unit 44 calculating an analysis parameter with respect to the input audio signal and judging from the analysis parameter whether data is embedded in the input audio signal and an extraction unit 45 extracting the data embedded in the audio signal according to a predetermined embedding method when the result of judgment of the embedding judgment unit 44 indicates data is embedded and outputting nothing when the result of judgment indicates no data is embedded.

Next, the operations of the data extraction apparatus illustrated in FIG. 4(B) will be explained.

The audio signal is input into the embedding judgment unit 44. This judges whether the audio signal had data embedded in it.

The result of judgment and the audio signal are input into the extraction unit 45. When the judgment in the judgment unit 44 indicates “data is embedded”, it is deemed that data has been embedded and the apparatus extracts the data from a predetermined data embedding position in the audio signal and outputs it. If “no data is embedded”, it is deemed that data has not been embedded and the apparatus outputs nothing.

Note that, when extracting data from an audio signal having data embedded in it, the same method as the embedding side is used to judge whether there is a part suitable for embedding data inside it. It is deemed that data is embedded at a part judged to be suitable for embedding data, and the data is extracted. Note that, while any data embedding method (embedding in a lower order n bit of a PCM signal etc.) may be used, it is necessary for the embedding side and the extracting side to share a predetermined embedding method.

### First Embodiment

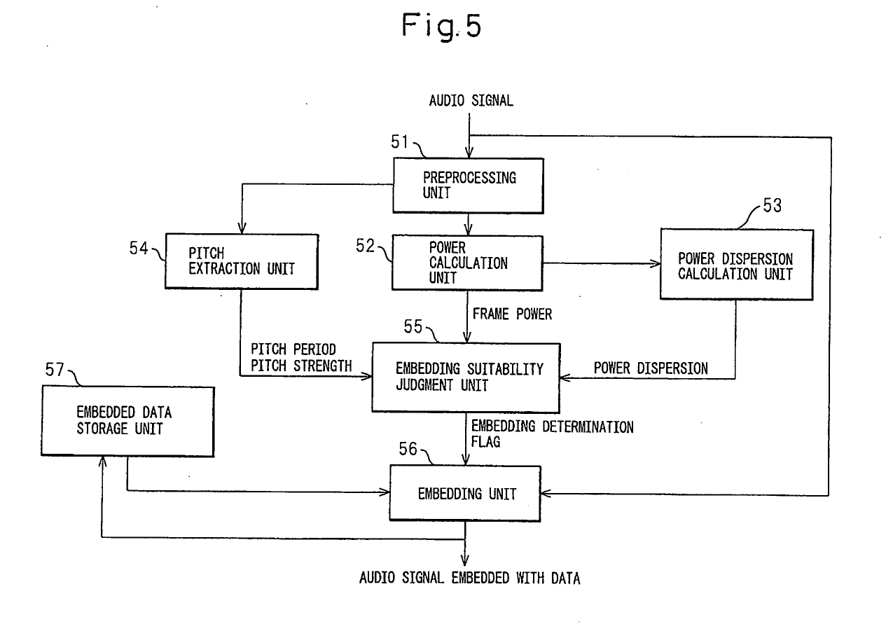

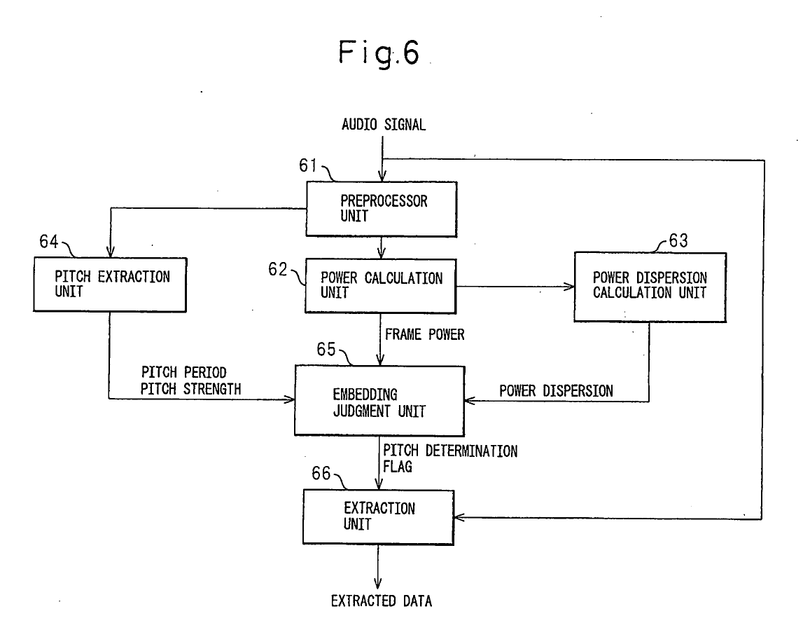

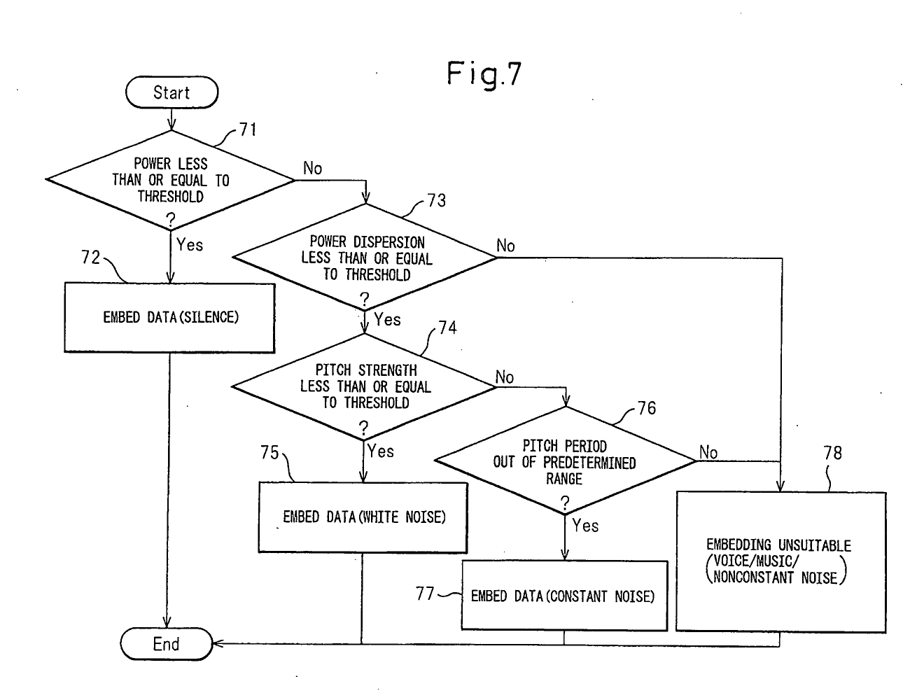

One example of the present invention applied to a telephone, Voice over Internet Protocol (VoIP) and other forms of voice communication is illustrated in FIG. 5, FIG. 6, and FIG. 7.

FIG. 5 is a block diagram illustrating the configuration of a data embedding apparatus according to a first embodiment of the present invention. In FIG. 5, the data embedding apparatus is provided with a preprocessing unit 51, power calculation unit 52, power dispersion unit 53, pitch extraction unit 54, embedding allowability judgment unit 55, embedding unit 56, and an embedded data storage unit 57. In the present embodiment, the input signal is processed in units of frames of a plurality of samples (for example, 160 samples). Further, the above analysis parameters are, in the first embodiment, the power, power dispersion, pitch period, and pitch strength of the input audio signal.

Next, the operation of the data embedding apparatus illustrated in the FIG. 5 will be explained.

First, the input signal of the present frame is input into the preprocessing unit 51. This sets the target embedding bits (for example one lowest order bit) to a default value. Any default value setting method may be used, however, for example, the target embedding bits are cleared to 0. Note that, the purpose of the default value setting processing is to allow for the same judgment to be performed on the embedding side and the extracting side even when there is no input signal prior to embedding data on the extracting side.

Next, the signal of the present frame, returned to the default value (for example, cleared to 0) by default value setting processing, is input into the power calculation unit 52. There, the average power of the frame is calculated according to Equation (1). In Equation (1), s(n,i) indicates the i-th input signal of the n-th frame, pw(n) indicates the average power of the n-th frame, and FRAMESIZE indicates the frame size.

$$\begin{matrix}[ Equation 1 ] & \\ pw ( n ) = \frac{{\sum }_{i = 0}^{FRAMESIZE - 1} {s ( n , i )}^{2}}{FRAMESIZE} & ( 1 )\end{matrix}$$

Next, the average power of the frame calculated by the power calculation unit 52 is input into the power dispersion calculation unit 53. This finds the power dispersion according to Equation (2). In Equation (2), σ(n) indicates the power dispersion of the n-th frame, and pw ave(n) indicates the average power from the n-th frame to the FRAMENUM frame.

$$\begin{matrix}[ Equation 2 ] & \\ σ ( n ) = \sqrt{\frac{{\sum }_{j = 0}^{FRAMENUM - 1} {\{ pw\_ave ( n ) - pw ( n - j ) \}}^{2}}{FRAMENUM}} & ( 2 )\end{matrix}$$

Next, the audio signal, returned to the default value (for example, cleared to 0) by the default value setting processing, is input into the pitch extraction unit 54. This determines the pitch strength and the pitch period in the present frame. Any method may be used for finding the pitch, however, Equation (3), for example, is used to calculate the normalized autocorrelation ac(k) of the audio signal, the maximum value of the ac(k) is made the pitch strength, and the k of ac(k) for the maximum value is made the pitch period. Note that, in Equation (3), M indicates the width for calculating the autocorrelation, and pitchₘᵢₙ and pitchₘₐₓ respectively indicate the minimum values and the maximum values for finding the pitch period.

$$\begin{matrix}[ Equation 3 ] & \\ ac ( k ) = \frac{{\sum }_{i = 0}^{M - 1} s ( i ) \times s ( i + k )}{\sqrt{{\sum }_{i = 0}^{M - 1} {s ( i )}^{2}}} ( {pitch}_{min} \leq k \leq {pitch}_{max} ) & ( 3 )\end{matrix}$$

The frame's average power, power dispersion, pitch period, and pitch strength found in the above way are input into the embedding allowability judgment unit 55. This judges according to the flow chart of FIG. 7 whether to embed data into the present frame, then outputs the embedding determination flag fin(n).

The present frame's input signal, embedding data, and the above embedding determination flag fin(n) are input into the embedding unit 56. This replaces a predetermined position of the input signal (for example, the one lowest order bit) with the embedding data and outputs the result when the embedding determination flag fin(n) indicates “data can be embedded”. When the embedding determination flag fin(n) indicates “data cannot be embedded”, the input signal is output as it is without modification.

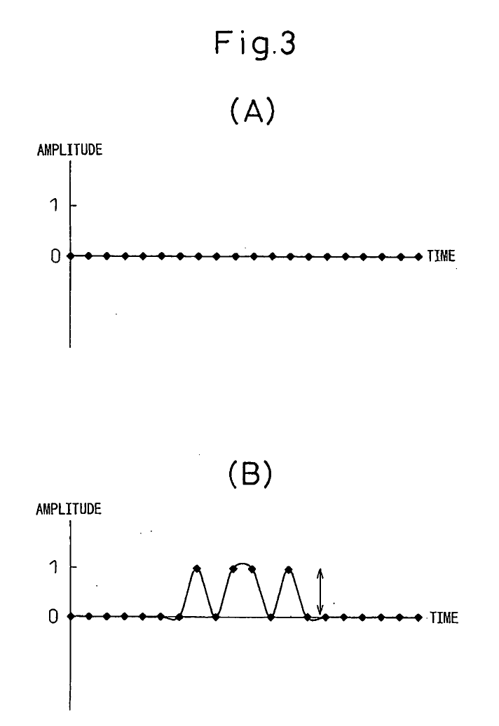

FIG. 7 is a flow chart explaining the operation of the embedding allowability judgment unit 55. In FIG. 7, at step 71, if the power output from the power calculation unit 52 is a predetermined threshold or less, because the input signal is a very small signal similar to that explained in for the prior art in FIG. 3, the audio quality will not change even if data is embedded in this interval. Accordingly, data can be embedded, and data is embedded at step 72.

Even if the judgment at step 71 is that the power is greater than the predetermined threshold, if the output of the power dispersion calculation unit 53 is the predetermined threshold or less at step 73 and if the output of the pitch extraction unit 54, that is, the pitch strength, is the predetermined threshold or less at step 74, the region is the white noise region. Accordingly, it is deemed data can be embedded, and data is embedded at step 75.

Further, if the pitch strength is greater than the above predetermined threshold at step 74 and the pitch period is outside of a predetermined range at step 76, the region is a region of constant noise such as automobile engine noise. Accordingly, it is deemed data can be embedded, and data is embedded at step 77.

When the power dispersion is greater than the above predetermined threshold at step 73 and when the pitch period is judged to not be outside the above predetermined threshold at step 76, the region is deemed to be a region of non-constant noise such as voices, music, or station announcements, and it is judged data cannot be embedded at step 78.

FIG. 6 is a block diagram illustrating the configuration of a data extraction apparatus according to the first embodiment of the present invention. In FIG. 6, the data extraction apparatus is provided with a preprocessing unit 61, power calculation unit 62, power dispersion calculation unit 63, pitch extraction unit 64, embedding judgment unit 65, and an extraction unit 66.

Next, the operation of the apparatus illustrated in FIG. 6 will be explained.

First, the input signal of the present frame is input into the preprocessing unit 61. This sets the target embedding bits (for example, the one lowest order bit) to a default value (for example, cleared to 0).

Next, the signal of the present frame, returned to the default value (for example, cleared to 0), is input into the power calculation unit 62. There, the average power of the frame is calculated according to Equation (1).

Next, the average power of the present frame calculated by the power calculation unit 62 is input into the power dispersion calculation unit 63. This determines the power dispersion according to Equation (2).

Next, the audio signal, returned to the default value (for example, cleared to 0) by the preprocessing unit 61, is used to find the pitch strength and the pitch period in the present frame at the pitch extraction unit 64. Any method may be used to find the pitch, however, for example, Equation (3) is used to calculate the normalized autocorrelation ac(k) of the audio signal, the maximum value of the ac(k) is made the pitch strength, and the k of ac(k) for the maximum value is made the pitch period.

The frame's average power, power dispersion, pitch period, and pitch strength determined by the above are input into the embedding allowability judgment unit 65. This judges whether to embed data into the present frame. The judgment, similar to the embedding side, is performed in accordance with the flow chart of FIG. 7. It is deemed that a part suitable for embedding data has data embedded in it and other parts do not have data embedded in it. The result of judgment is output as the embedding judgment flag fout(n) from the embedding judgment unit 65.

Finally, the present frame's input signal and embedding data and the embedding judgment flag fout(n) calculated by the embedding judgment unit 65 are input into the embedding unit 66. This deems that data is embedded in the input signal when the embedding determination flag fout(n) indicates “data embedded”, extracts the predetermined position of the input signal (for example one lowest order bit) as the embedding data, and outputs it. When the embedding determination flag fout(n) indicates “no data embedded”, nothing is output.

In the first embodiment, the average power, power dispersion, pitch period, and pitch strength are calculated from the input signal and it is judged whether the present frame can have data embedded in it. Therefore, it is possible to appropriately select only frames suitable for embedding data and embed them with data, so data can be embedded without causing a deterioration in audio quality. Further, by having the preprocessing unit 51 set the target embedding bits to a default value (for example clearing them to 0), then calculate the judgment parameters, even when there is no signal prior to embedding data at the receiving side of the voice communication etc., it is possible to perform judgment the same as the embedding side at the extraction side, so it is possible to accurately extract embedded data.

Note that the first embodiment used the average power, power dispersion, pitch period, and pitch strength of the input signal as analysis parameters to judge whether data can be embedded, however. the analysis parameters are not limited to these. For example, the spectral envelope shape of the input signal and any other parameters may also be used.

### Second Embodiment

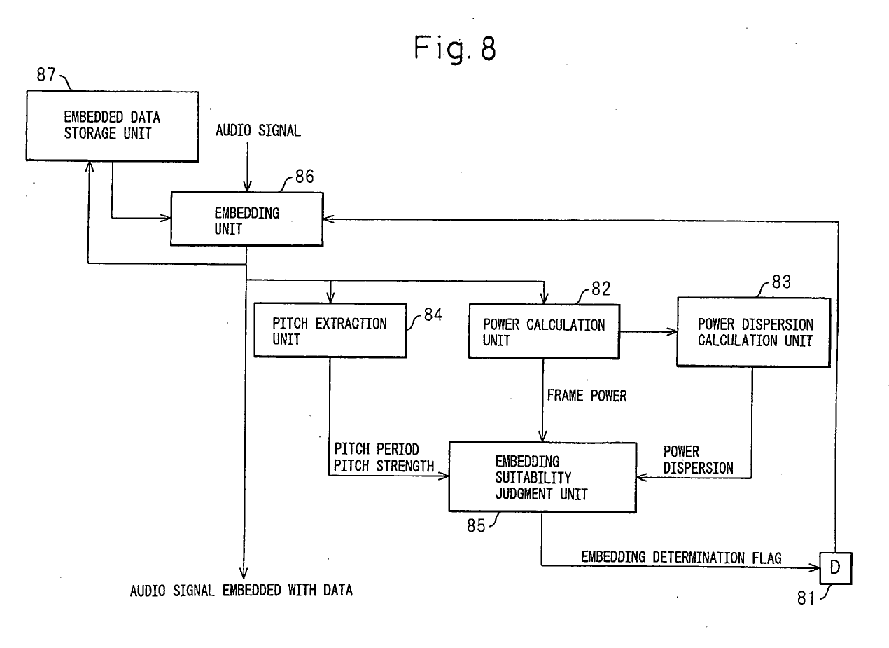

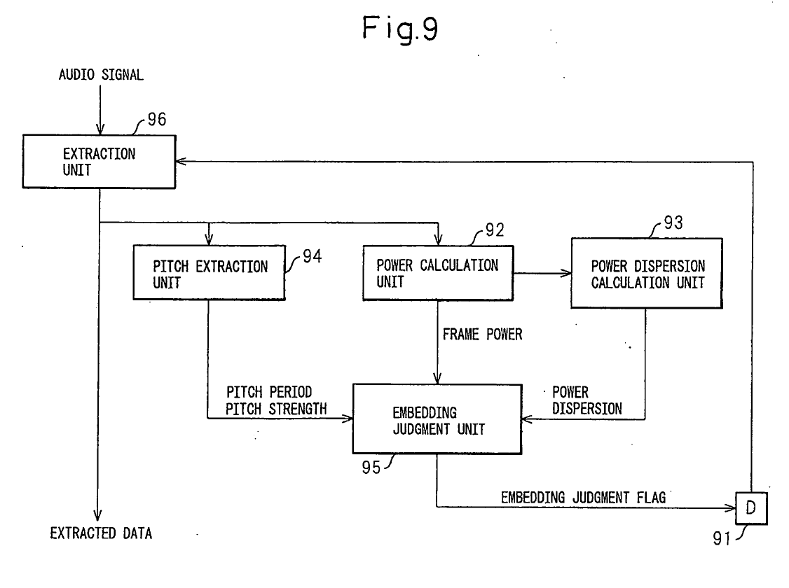

A different embodiment of the present invention applied to a telephone, Voice over Internet Protocol (VoIP), and other forms of voice communication is illustrated in FIG. 8 and FIG. 9. FIG. 8 is a block diagram illustrating the configuration of a data embedding apparatus according to a second embodiment of the present invention, and FIG. 9 is a block diagram illustrating the configuration of a data extraction apparatus according to the second embodiment.

In FIG. 8, the data embedding apparatus according to the second embodiment of the present invention is provided with a delay element 81 illustrated as a “D” block, power calculation unit 82, power dispersion unit 83, pitch extraction unit 84, embedding allowability judgment unit 85, embedding unit 86, and embedded data storage unit 87. The delay element 81 delays the input signal by one frame.

In FIG. 9, the data extraction apparatus according to the second embodiment of the present invention is provided with the delay element 91 illustrated as a “D” block, power calculation unit 92, power dispersion unit 93, pitch extraction unit 94, embedding allowability judgment unit 95, and embedding unit 96. The delay element 91 delays the input signal by one frame.

The second embodiment differs from the first embodiment in the point that the target embedding bits are not set to a default value (for example, not cleared to 0) by preprocessing and the point that a signal from the previous frame in which data had been embedded (or not embedded) is used to calculate the judgment parameters determining the allowability of embedding data of the present frame. The rest of the processing is the same. By determining the allowability of embedding data in the present frame by the signal up to the previous frame, the same judgment may be performed at the embedding side and extracting side without setting the target embedding bits to a default value (for example cleared to 0).

In the second embodiment as well, in the same way as the first embodiment, the average power, power dispersion, pitch period, and pitch strength from the input signal are calculated as the analysis parameters to judge the allowability of embedding data of the present frame. Therefore, it is possible to appropriately select only frames suitable for embedding data and embed them with data, so data can be embedded without causing a deterioration in audio quality. Further, by using the post-embedding signals up the previous frame to calculate the analysis parameters, even when there is no signal prior to embedding data at the receiving side of the voice communication etc., the extracting side can perform as the same judgment as the embedding side, so can accurately extract embedded data.

Note that, in the present embodiment as well, the input signal's average power, power dispersion, pitch period, and pitch strength are used as analysis parameters to judge if data can be embedded, however the analysis parameters are not limited to these. For example, the spectral envelope shape of the input signal and any other parameters may also be used.

### Third Embodiment

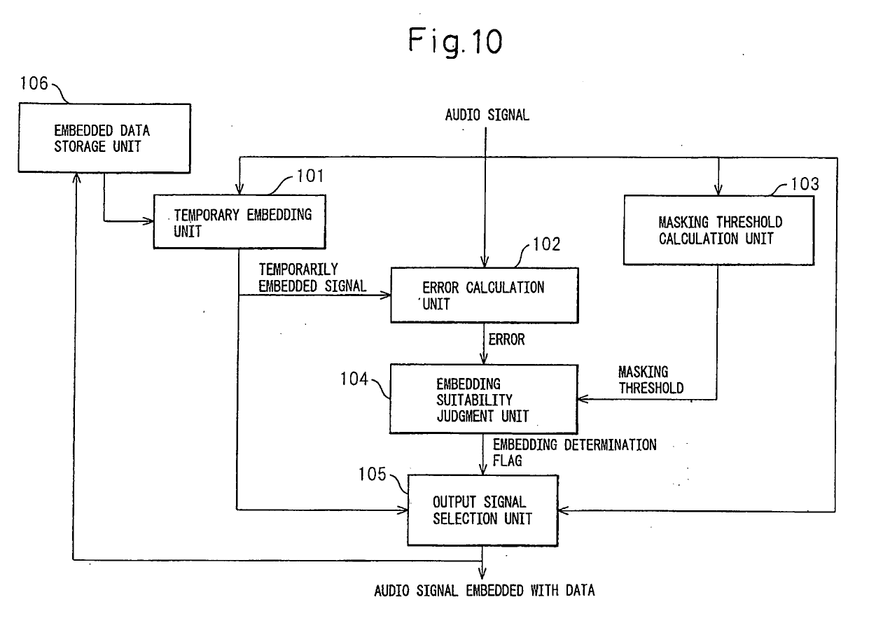

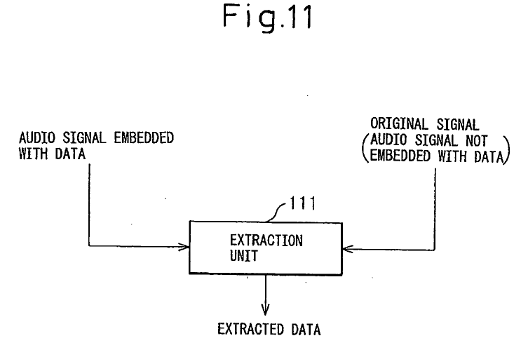

A third embodiment of the present invention of the case of application to music, movies, drama, and other rich content is illustrated in FIG. 10 and FIG. 11.

FIG. 10 is a block diagram illustrating the configuration of a data embedding apparatus according to a third embodiment, and FIG. 11 is a block diagram illustrating the configuration of a data extraction apparatus according to the third embodiment.

In FIG. 10, the data embedding apparatus according to the third embodiment is provided with a temporary embedding unit 101, error calculation unit 102, masking threshold calculation unit 103, embedding allowability judgment unit 104, output signal selection unit 105, and embedded data storage unit 106.

In FIG. 11, the data extraction apparatus according to the third embodiment inputs a post-embedded signal and the original signal without data embedded into the extraction unit 111. If the two signals are different, it is deemed that data has been embedded and data is extracted from a predetermined data embedding position.

In the third embodiment as well, similar to the first and second embodiments, processing is performed on the input signal in units of frames of pluralities of samples. First, the processing in the data embedding apparatus of the third embodiment will be explained in further detail below.

First, the input audio signal is input into the masking threshold calculation unit 103. This calculates the masking threshold in the present frame. Note that, the masking threshold indicates the maximum amount of noise where the difference is not perceived even if adding the noise to the input signal. Any method may be used to find the masking threshold, however, for example, there is the method of finding it using the psychoacoustic model in ISO/IEC 13818-7:2003, Advanced Audio Coding.

Next, the input audio signal is input into the temporary embedding unit 101. This creates a temporarily embedded signal in which data is temporarily embedded according to a predetermined embedding method (for example, embedding data in one lowest order bit). This is then output from the temporary embedding unit 101.

Next, the input audio signal and the temporarily embedded signal calculated in the temporary embedding unit 101 are input into the error calculation unit 102. This calculates the error between the input signal and temporarily embedded signal.

Next, the masking threshold calculated by the masking threshold calculation unit 103 and the error calculated by the error calculation unit 102 are input into the embedding allowability judgment unit 104. This judges the allowability of embedding data of the present frame. If the error calculated by the error calculation unit 102 is the masking threshold calculated by the masking threshold calculation unit 103 or less, the embedding allowability judgment unit 104 deems that data can be embedded, while if not, it deems data cannot be embedded, and outputs the result.

Next, the input signal, the temporarily embedded signal calculated by the temporary embedding unit 101, and the output of the embedding allowability judgment unit 104, that is, the result of judgment of embedding allowability, are input into the output signal selection unit 105. If data can be embedded, the temporarily embedded signal calculated by the temporary embedding unit 101 is output from the output signal selection unit 105, while if data cannot be embedded, the input signal is output as is from the output signal selection unit 105. The output of the output signal selection unit 105 is stored in the embedded data storage unit 106, whereby the judgment of which data is to be embedded next becomes possible at the embedded data storage unit 106.

In the third embodiment, data is embedded in music, movies, drama, and other rich content only at places where perception of acoustic differences is avoided by using the masking threshold. By using this sort of configuration, it is possible to embed data without causing a deterioration in audio quality even for rich content in which changes in audio quality are harder to allow in comparison to voice communication and the like. Note that, in the present embodiment, allowability of embedding data is judged using only the masking threshold, however, the invention is not limited to this. For example, the power etc. of the input signal as in the first and second embodiments may be used as judgment parameters.

### INDUSTRIAL APPLICABILITY

As is clear from the above explanation, according to the present invention, it is judged from analysis parameters such as power change, pitch strength, pitch frequency, frequency spectrum distribution, or masking threshold whether a part of the audio signal is a part suitable for embedding data, that is, whether it is a part in which the changes in audio quality are not perceived even if data is embedded or a part in which changes in audio quality can be accepted. By embedding data only in cases when the part is deemed to be suitable as an embedding part, data can be embedded in a voice signal without embedding of data in a part unsuitable for embedding data causing an unacceptable change in audio quality and without causing a drop in the amount of embedded data.

Further, it is possible to extract data embedded in such a way.

What is claimed is:

1. A data embedding apparatus comprising:
an embedding allowability judgment unit calculating an analysis parameter with respect to an input audio signal, judging based on the analysis parameter if the input audio signal corresponds to any of a “part where a change in audio quality caused by embedding data is not audibly perceived”, a “part where a change in audio quality caused by embedding data is audibly acceptable”, and a “part where a change in audio quality is audibly unacceptable”, and allowing embedding of data in the input audio signal if the input audio signal is either a “part where a change in audio quality caused by embedding of data is not audibly perceived” or a “part where a change in audio quality caused by embedding of data is audibly acceptable”; and
an embedding unit outputting the audio signal embedded with data in the allowable part when the result of judgment of the embedding allowability judgment unit is embedding is possible and outputting the audio signal as is when the result of judgment of the embedding allowability judgment unit is that embedding is not possible.

2. The data embedding apparatus as set forth in claim 1, wherein the embedding allowability judgment unit comprises:
a preprocessing unit setting a target embedding part of the input audio signal as a default value and outputting the same;
at least one characteristic quantity calculation unit from among a power calculation unit calculating a characteristic quantity relating to a power of the audio signal having the target embedding part set to the default value by the preprocessing unit;
a power dispersion calculation unit calculating a characteristic quantity relating to a dispersion of power using the characteristic quantity relating to the power of the audio signal calculated by the power calculation unit and a characteristic quantity relating to the power of a past audio signal; and
a pitch extraction unit calculating a characteristic quantity relating to periodicity using the audio signal having the target embedding part set to the default value; and
a judgment unit judging allowability of embedding data using a characteristic quantity calculated by a characteristic quantity calculation unit.

3. The data embedding apparatus as set forth in claim 1 wherein the embedding allowability judgment unit comprises:
at least one characteristic quantity calculation unit from among
a power calculation unit calculating a characteristic quantity relating to a power of the input audio signal;
a power dispersion calculation unit calculating a characteristic quantity relating to a dispersion of power using the characteristic quantity relating to the power of the audio signal calculated by the power calculation unit and a characteristic quantity relating to the power of a past audio signal; and
a pitch extraction unit calculating a characteristic quantity relating to periodicity using the audio signal; and
a judgment unit judging allowability of embedding data using a characteristic quantity calculated by a characteristic quantity calculation unit;
wherein
the embedding unit embeds data or processes output of the audio signal based on the result of judgment of the judgment unit for one frame before the input audio signal.

4. The data embedding apparatus as set forth in claim 1, wherein
the embedding allowability judgment unit comprises:
a masking threshold calculation unit calculating a masking threshold of the input audio signal,
a temporary embedding unit temporarily embedding data in the audio signal,
an error calculation unit calculating an error between a temporarily embedded signal in which data is embedded by the temporary embedding unit and the audio signal, and
a judgment unit judging allowability of embedding data using the masking threshold and the error.

5. A voice communication system comprising, on a transmission side, a data embedding apparatus comprising:
an embedding allowability judgment unit calculating an analysis parameter with respect to an input audio signal, judging based on the analysis parameter if the input audio signal corresponds to any of a “part where a change in audio quality caused by embedding data is not audibly perceived”, a “part where a change in audio quality caused by embedding data is audibly acceptable”, and a “part where a change in audio quality is audibly unacceptable”, and allowing embedding of data in the input audio signal if the input audio signal is either a “part where a change in audio quality caused by embedding of data is not audibly perceived” or a “part where a change in audio quality caused by embedding of data is audibly acceptable”; and
an embedding unit outputting the audio signal embedded with data in the allowable part when the result of judgment of the embedding allowability judgment unit is embedding is possible and outputting the audio signal as is when the result of judgment of the embedding allowability judgment unit is that embedding is not possible; and,
on a receiving side, a data extraction apparatus comprising:
an embedding judgment unit calculating an analysis parameter with respect to the input audio signal and judging, based on the analysis parameter, whether data is embedded in the input audio signal and
an extraction unit extracting data embedded in the audio signal according to a predetermined embedding method when a result of judgment of the embedding judgment unit is data is embedded and outputting nothing when the result of judgment is no data is embedded.

6. The voice communication system as set forth in claim 5, wherein, at the transmission side, the embedding allowability judgment unit comprises:
a preprocessing unit setting a target embedding part of the input audio signal as a default value and outputting the same;
at least one characteristic quantity calculation unit from among
a power calculation unit calculating a characteristic quantity relating to a power of the audio signal having the target embedding part set to the default value by the preprocessing unit;
a power dispersion calculation unit calculating a characteristic quantity relating to a dispersion of power using the characteristic quantity relating to the power of the audio signal calculated by the power calculation unit and a characteristic quantity relating to the power of a past audio signal; and
a pitch extraction unit calculating a characteristic quantity relating to periodicity using the audio signal having the target embedding part set to the default value; and
a judgment unit judging allowability of embedding data using a characteristic quantity calculated by a characteristic quantity calculation unit; and,
at the receiving side, the embedding judgment unit comprises:
a preprocessing unit setting a target embedding part of the input audio signal as a default value and outputting the same;
at least one characteristic quantity calculation unit from among
a power calculation unit calculating a characteristic quantity relating to a power of the audio signal having the target embedding part set to the default value by the preprocessing unit;
a power dispersion calculation unit calculating a characteristic quantity relating to a dispersion of power using the characteristic quantity relating to the power of the audio signal calculated by the power calculation unit and a characteristic quantity relating to the power of a past audio signal; and
a pitch extraction unit calculating a characteristic quantity relating to periodicity using the audio signal having the target embedding part set to the default value: and
an embedding identification unit identifying whether data is embedded using a characteristic quantity calculated by a characteristic quantity calculation unit.

7. The voice communication system as set forth in claim 5, wherein, at the transmission side, the embedding allowability judgment unit comprises:
at least one characteristic quantity calculation unit among
a power calculation unit calculating a characteristic quantity relating to a power of the input audio signal;
a power dispersion calculation unit calculating a characteristic quantity relating to dispersion of the power using the characteristic quantity relating to the power of the audio signal calculated by the power calculation unit and a characteristic quantity relating to the power of a past audio signal; and
a pitch extraction unit calculating a characteristic quantity relating to periodicity using the audio signal; and
a judgment unit judging allowability of embedding data using a characteristic quantity calculated by a characteristic quantity calculation unit;
wherein
the embedding unit embeds data or processes output of the audio signal based on the result of judgment of the judgment unit for one frame before the input audio signal; and
at the receiving side, the embedding judgment unit comprises:
at least one characteristic quantity calculation unit among
a power calculation unit calculating a characteristic quantity relating to a power of the input audio signal;
a power dispersion calculation unit calculating a characteristic quantity relating to dispersion of the power using the characteristic quantity relating to the power of the audio signal calculated by the power calculation unit and a characteristic quantity relating to the power of a past audio signal; and
a pitch extraction unit calculating a characteristic quantity relating to periodicity using the audio signal; and
an embedding identification unit identifying whether data is embedded using a characteristic quantity calculated by a characteristic quantity calculation unit;
wherein
the extraction unit extracts data based on a result of judgment of the embedding identification unit for one frame before the input audio signal.

8. The data embedding method comprising:
judging whether or not data is allowed to be embedded into an input audio signal by calculating an analysis parameter with respect to the input audio signal, judging based on the analysis parameter if the input audio signal corresponds to any of a “part where a change in audio quality caused by embedding data is not audibly perceived”, a “part where a change in audio quality caused by embedding data is audibly acceptable”, and a “part where a change in audio quality is audibly unacceptable”, and allowing embedding of the data in the input audio signal if the input audio signal is either a “part where a change in audio quality caused by embedding of data is not audibly perceived” or a “part where a change in audio quality caused by embedding of data is audibly acceptable”; and
outputting the audio signal embedded with data in the allowable part when the result of judgment of the judgment step is embedding is possible and outputting the audio signal as is when the result of judgment of the judgment step is that embedding is not possible.

9. The data embedding method as set forth in claim 8, wherein the judging whether or not data is allowed to be embedded into an input audio signal comprises:
preprocessing for setting a target embedding part of the input audio signal as a default value and outputting the same;
at least one characteristic quantity calculation from among
power calculation for calculating a characteristic quantity relating to a power of the audio signal having the target embedding part set to the default value by the preprocessing;
a power dispersion calculation for calculating a characteristic quantity relating to a dispersion of power using the characteristic quantity relating to the power of the audio signal calculated by the power calculation and a characteristic quantity relating to the power of a past audio signal; and
a pitch extraction for calculating a characteristic quantity relating to periodicity using the audio signal having the target embedding part set to the default value; and
a judgment for judging allowability of embedding data using a characteristic quantity calculated by the characteristic quantity calculation.

10. The data embedding method as set forth in claim 8 wherein judging whether or not data is allowed to be embedded into an input audio signal comprises:
at least one characteristic quantity calculation from among
a power calculation for calculating a characteristic quantity relating to a power of the input audio signal;
a power dispersion calculation for calculating a characteristic quantity relating to a dispersion of power using the characteristic quantity relating to the power of the audio signal calculated by the power calculation and a characteristic quantity relating to the power of a past audio signal; and
a pitch extraction for calculating a characteristic quantity relating to periodicity using the audio signal; and
a judgment for judging allowability of embedding data using a characteristic quantity calculated by a characteristic quantity calculation step;
wherein
the embedding embeds data or processes output of the audio signal based on the result of judgment of the judgment for one frame before the input audio signal.

11. The data embedding method as set forth in claim 8, wherein
judging whether or not data is allowed to be embedded into an input audio signal comprises:
a masking threshold calculation for calculating a masking threshold of the input audio signal;
a temporary embedding for temporarily embedding data in the audio signal;
an error calculation for calculating an error between a temporarily embedded signal in which data is embedded by the temporary embedding and the audio signal; and
a judgment for judging allowability of embedding data using the masking threshold and the error.

12. A voice communication method comprising, on a transmission side, a data embedding method comprising
judging whether or not data is allowed to be embedded into an input audio signal by calculating an analysis parameter with respect to the input audio signal, judging based on the analysis parameter if the input audio signal corresponds to any of a “part where a change in audio quality caused by embedding data is not audibly perceived”, a “part where a change in audio quality caused by embedding data is audibly acceptable”, and a “part where a change in audio quality is audibly unacceptable”, and allowing embedding of the data in the input audio signal if the input audio signal is either a “part where a change in audio quality caused by embedding of data is not audibly perceived” or a “part where a change in audio quality caused by embedding of data is audibly acceptable”; and
an embedding for outputting the audio signal embedded with data in the allowable part when the result of the judging whether or not data is allowed to be embedded is embedding is possible and outputting the audio signal as is when the result of the judging whether or not data is allowed to be embedded is that embedding is not possible; and,
on a receiving side, a data extraction method comprising:
an embedding judgment for calculating an analysis parameter with respect to the input audio signal and judging, based on the analysis parameter, whether data is embedded in the input audio signal; and
an extraction for extracting data embedded in the audio signal according to a predetermined embedding method when a result of judgment of the embedding judgment is data is embedded and outputting nothing when the result of judgment is no data is embedded.

13. A voice communication method as set forth in claim 12, wherein, at the transmission side, the embedding allowability judgment step comprises:
preprocessing for setting a target embedding part of the input audio signal as a default value and outputting the same;
at least one characteristic quantity calculating from among
power calculating for calculating a characteristic quantity relating to a power of the audio signal having the target embedding part set to the default value by the preprocessing step;
power dispersion calculating for calculating a characteristic quantity relating to a dispersion of power using the characteristic quantity relating to the power of the audio signal calculated by the power calculation step and a characteristic quantity relating to the power of a past audio signal; and
pitch extracting for calculating a characteristic quantity relating to periodicity using the audio signal having the target embedding part set to the default value; and
judging for judging allowability of embedding data using a characteristic quantity calculated by a characteristic quantity calculation step and,
at the receiving side, the judging allowablility of embedding comprises:
preprocessing for setting a target embedding part of the input audio signal as a default value and outputting the same;
at least one characteristic quantity calculating from among
power calculating for calculating a characteristic quantity relating to a power of the audio signal having the target embedding part set to the default value by the preprocessing;
power dispersion calculating for calculating a characteristic quantity relating to a dispersion of power using the characteristic quantity relating to the power of the audio signal calculated by the power calculating and a characteristic quantity relating to the power of a past audio signal; and
pitch extracting for calculating a characteristic quantity relating to periodicity using the audio signal having the target embedding part set to the default value; and
embedding identifying for identifying whether data is embedded using a characteristic quantity calculated by a characteristic quantity calculation step.

14. A voice communication method as set forth in claim 12, wherein, at the transmission side, the embedding allowability judging comprises:
at least one characteristic quantity calculating among
power calculating for calculating a characteristic quantity relating to a power of the input audio signal;
power dispersion calculating for calculating a characteristic quantity relating to dispersion of the power using the characteristic quantity relating to the power of the audio signal calculated by the power calculating and a characteristic quantity relating to the power of a past audio signal; and
a pitch extracting for calculating a characteristic quantity relating to periodicity using the audio signal; and
judging for judging allowability of embedding data using a characteristic quantity calculated by a characteristic quantity calculation step,
the embedding embeds data or processes output of the audio signal based on the result of judgment of the judgment step for one frame before the input audio signal and wherein,
at the receiving side, the embedding judging comprises:
at least one characteristic quantity calculating among
power calculating for calculating a characteristic quantity relating to a power of the input audio signal;
power dispersion calculating for calculating a characteristic quantity relating to dispersion of the power using the characteristic quantity relating to the power of the audio signal calculated by the power calculating and a characteristic quantity relating to the power of a past audio signal; and
pitch extracting for calculating a characteristic quantity relating to periodicity using the audio signal; and
identifying for identifying whether data is embedded using a characteristic quantity calculated by a characteristic quantity calculation step;
wherein
the extracting extracts data based on a result of the identifying for one frame before the input audio signal.
